(19) United States
(12) Patent Application Publication
(10) Pub. No.: US 2006/0116874 A1
(43) Pub. Date: Jun. 1, 2006

(54) Noise-dependent postfiltering

(76) Inventors: Jonas Samuelsson, Solna (SE); Willem Bastiaan Kleijn, Stocksund (SE); Volodya Grancharov, Uppsala (SE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/540,741

(22) PCT Filed: Oct. 24, 2003
(86) PCT No.: PCT/SE03/01657

§ 371 Date: Jun. 24, 2005

(51) Int. Cl. G10L 21/02

(52) U.S. Cl. 704/228; 704/233

(57) ABSTRACT

A method of filtering a speech signal is presented. The method involves providing a filter (404) suited for reduction of distortion caused by speech coding, estimating acoustic noise in the speech signal, adapting the filter in response to the estimated acoustic noise to obtain an adapted filter, and applying the adapted filter to the speech signal so as to reduce acoustic noise and distortion caused by speech coding in the speech signal.

### FIELD OF THE INVENTION

The present invention relates to the fields of speech coding, speech enhancement and mobile telecommunications. More specifically, the present invention relates to a method of filtering a speech signal, and a speech filtering device.

### BACKGROUND OF THE INVENTION

Speech, i.e. acoustic energy, is analogue by its nature. It is convenient, however, to represent speech in digital form for the purposes of transmission or storage. Pure digital speech data obtained by sampling and digitizing an analog audio signal requires a large channel bandwidth and storage capacity, respectively. Hence, digital speech is normally compressed according to various known speech coding standards.

CELP codecs (Code Excited Linear Prediction encoder/decoder) are commonly used for speech encoding and decoding. For instance, the EFR (Enhanced Full Rate) codec which is used in GSM (Global System for Mobile communications), and the AMR (Adaptive Multi-Rate) codec which is used in UMTS (Universal Mobile Telecommunications System), are both of CELP type. A CELP codec operates by short-term and long-term modeling of speech formation. Short-term filters model the formants of the voice spectrum, i.e. the human voice formation channels, whereas long-term filters model the periodicity or pitch of the voice, i.e. the vibration of the vocal chords. Moreover, a weighting filter operates to attenuate frequencies which are perceptually less important and emphasizes those frequencies that have more effect on the perceived speech quality.

FIG. 3 illustrates the decoding part of a speech codec 300 according to the prior art. Speech coding by CELP or other codecs causes distortion of the speech signal, known as quantization noise. To this end, a postfilter 304 is provided to reduce the quantization noise in the output signal s_{decoded} from a speech decoder 302. Postfilter technology is described in detail in “Adaptive postfiltering for quality enhancement of coded speech”, J. -H. Chen and A. Gersho, IEEE Trans. Speech Audio Process., vol 3, pp 59-71, 1995, hereby incorporated by reference. The postfilter reduces the effect of quantization noise by emphasizing the formant frequencies and deemphasizing (attenuating) the valleys in between.

Another type of noise which may affect the performance of a speech communication system is acoustic noise. Acoustic noise, or background noise, means all kinds of background sounds which are not intentionally part of the actual speech signal and are caused by noise sources such as weather, traffic, equipment, people other than the intended speaker, animal, etc.

Background noise is conventionally handled by separate noise suppression systems such as Wiener filters or spectral subtraction schemes. Such solutions are however computationally expensive and are not feasible for integration with speech codecs.

U.S. Pat. No. 6,584,441 discloses a speech decoder with an adaptive postfilter, the coefficients or weighting factors of which are adapted to the variable bit rate of audio frames and are moreover adjusted on the basis of whether each frame contains a voiced speech signal, an unvoiced speech signal or background noise. In more particular, it is observed in U.S. Pat. No. 6,584,441 that since a standard postfilter is designed for voiced speech signals, any background noise present in the speech signal may cause distortion to the output signal of the postfilter. Thus U.S. Pat. No.6,584,441 proposes detecting background noise, as an SNR level (Signal to Noise Ratio), in the decoded speech signal and weakening the postfiltering for frames with background noise so as to avoid aforesaid distortion. For frames that contain a voiced speech signal, no adaptation to background noise is made. Thus, in effect this solution means that the background noise characteristics of a speech signal are essentially maintained—they are not worsened by the postfiltering but they are on the other hand not improved either.

### SUMMARY OF THE INVENTION

In view of the above, an objective of the invention is to solve or at least reduce the problems discussed above. In particular, an objective is to reduce the effect of acoustic background noise on speech coding systems with minor additional computational effort.

Generally, the above objectives are achieved by a method of filtering a speech signal, a speech filtering device, a speech decoder, a speech codec, a speech transcoder, a computer program product, an integrated circuit, a module and a station for a mobile telecommunications network according to the attached independent patent claims.

One aspect of the invention is a method of filtering a speech signal, involving the steps of

providing a filter suited for reduction of distortion caused by speech coding;

estimating acoustic noise in said speech signal;

adapting said filter in response to the estimated acoustic noise to obtain an adapted filter; and

applying said adapted filter to said speech signal so as to reduce acoustic noise and distortion caused by speech coding in said speech signal.

Such a method provides an improvement over the state-of-the-art in noise reduction in two ways: 1) the background noise and quantization noise are jointly handled and reduced using one algorithm, and 2) the computational complexity of this algorithm has been found to be small compared to that of a speech coding/decoding algorithm and much smaller than conventional separate acoustic noise suppression methods.

Said step of adapting said filter may involve adjusting filter coefficients of said filter. Moreover, said steps of estimating, adapting and applying may be performed for portions of said speech signal which contain speech as well as for portions which do not contain speech.

Advantageously, any known postfilter of an existing speech coding standard may be used for implementing aforesaid method, wherein a set of postfilter coefficients—that would be constant in a postfilter of the prior art—will be modified based on detected acoustic noise, continuously on a frame-by-frame basis for frames that contain speech as well as for frames that do not.

Thus, the filter may include a short-term filter function designed for attenuation between spectrum formant peaks of said speech signal, wherein said filter coefficients include at least one coefficient that controls the frequency response of said short-term filter function. The filter may also include a spectrum tilt compensation function, wherein said filter coefficients include at least one coefficient that controls said spectrum tilt compensation function.

The acoustic noise in said speech signal may advantageously be estimated as relative noise energy (SNR) and noise spectrum tilt.

The values for said filter coefficients may be selected from a lookup table, which maps a plurality of values of estimated acoustic noise to a plurality of filter coefficient values. Advantageously, this lookup table is generated in advance or “off-line” by: adding different artificial noise power spectra having given parameter(s) of acoustic noise to different clean speech power spectra; optimizing a predetermined distortion measure by applying said filter to different combinations of clean speech power spectra and artificial noise power spectra; and, for said different combinations, saving in said lookup table those filter coefficient values, for which said predetermined distortion measure is optimal, together with corresponding value(s) of said given parameter(s) of acoustic noise.

Said predetermined distortion measure may include Spectral Distortion (SD), and said given parameters of acoustic noise may include relative noise energy (SNR) and noise spectrum tilt. Advantageously, when generating the lookup table, the filter coefficients can be optimized for a particular type of noise (e.g. car noise) for later use in such an environment.

Said steps of estimating, adapting and applying may advantageously be performed after a step of decoding said speech signal, for instance in a speech codec, i.e. as a noise-suppressing post-processing of a decoded speech signal. Alternatively, the steps may be performed before a step of encoding said speech signal, for instance in a speech codec, i.e. as a noise-suppressing pre-processing of a speech signal before it is encoded.

After said step of estimating acoustic noise, the method may decide whether the estimated relative noise energy for a current speech frame is below a predetermined threshold, and if so, choose not to perform said steps of adapting filter coefficients and applying said filter, and instead perform energy attenuation on the current speech frame so as to suppress acoustic noise in a speech pause.

Other objectives, features and advantages of the present invention will appear from the following detailed disclosure, from the attached dependent claims as well as from the drawings.

### BRIEF DESCRIPTION OF THE DRAWINGS

Embodiments of the present invention will now be described in more detail, reference being made to the enclosed drawings, in which:

FIG. 1 is a schematic illustration of a telecommunication system, in which the present invention may be applied.

FIG. 2 is a schematic block diagram illustrating some of the elements of FIG. 1.

FIG. 3 is a schematic block diagram of a speech decoder including a postfilter according to the prior art.

FIG. 4 is a schematic block diagram of a speech filtering device including a speech decoder with a noise-dependent postfilter according to an embodiment of the present invention.

FIG. 5 is a flowchart diagram of a noise-dependent postfiltering method according to one embodiment.

FIG. 6 illustrates a training algorithm for pre-computing filter coefficients.

FIGS. 7 and 8 illustrate the behavior of filter coefficients obtained through the training algorithm.

FIG. 9 illustrates the performance of a noise estimation algorithm used in one embodiment.

FIG. 10 illustrates the performance of the noise-dependent postfiltering method.

### DETAILED DISCLOSURE OF EMBODIMENTS

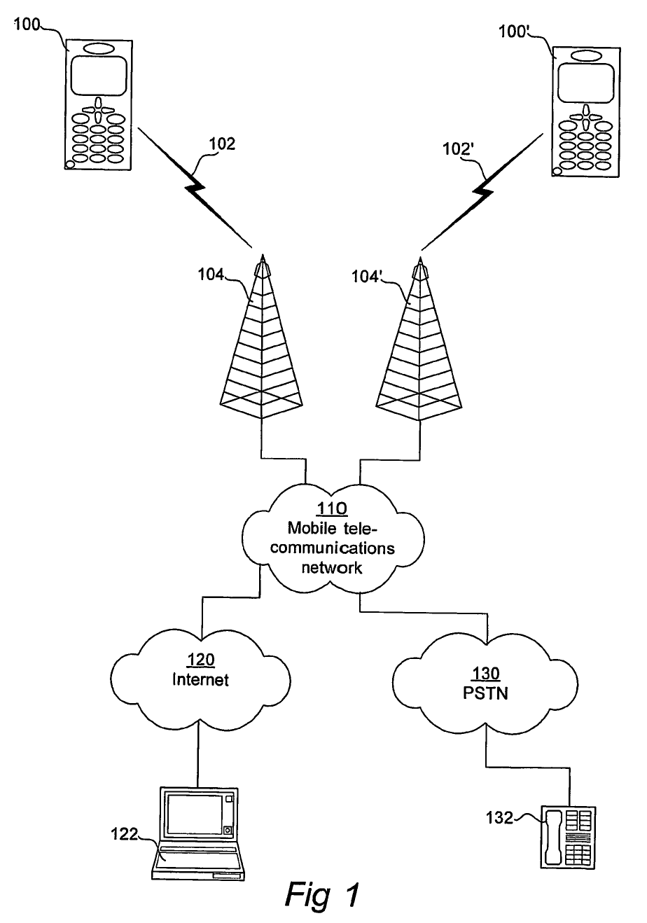

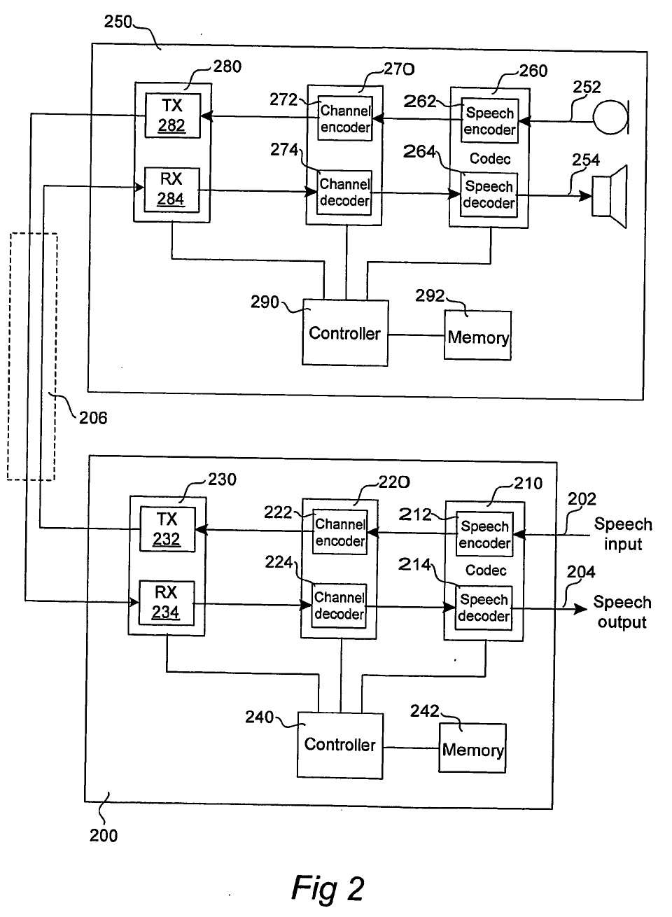

A telecommunication system in which the present invention may be applied will first be described with reference to FIGS. 1 and 2. Then, the particulars of the noise-dependent postfilter according to the invention will be described with reference to the remaining FIGS.

In the system of FIG. 1, audio data may be communicated between various units 100, 100′, 122 and 132 by means of different networks 110, 120 and 130. The audio data may represent speech, music or any other type of acoustic information. Within the context of the present invention, such audio data will represent speech. Hence, speech may be communicated from a user of a stationary telephone 132 through a public switched telephone network (PSTN) 130 and a mobile telecommunications network 110, via a base station 104 or 104′ thereof across a wireless communication link 102 or 102′ to a mobile terminal 100 or 100′, and vice versa. The mobile terminals 100, 100′ may be any commercially available devices for any known mobile telecommunications system, such as GSM, UMTS, D-AMPS or CDMA2000 Moreover, the system includes a computer 122 which is connected to a global data network 120 such as the Internet and is provided with software for IP (Internet Protocol) telephony. The system illustrated in FIG. 1 serves exemplifying purposes only, and thus various other situations where speech data is communicated between different units are possible within the scope of the invention.

FIG. 2 presents a general block diagram of a mobile audio data transmission system, including a mobile terminal 250 and a network station 200. The mobile terminal 250 may for instance represent the mobile terminal 100 of FIG. 1, whereas the network station 200 may represent the base station 104 of the mobile telecommunications network 110 in FIG. 1.

The mobile terminal 250 may communicate speech through a transmission channel 206 (e.g. the wireless link 102 between the mobile terminal 100 and the base station 104 in FIG. 1) to the network station 200. A microphone 252 receives acoustic input from a user of the mobile terminal 250 and converts the input to a corresponding analog electric signal, which is supplied to an speech encoding/decoding block 260. This block has a speech encoder 262 and a speech decoder 264, which together form a speech codec. The analog microphone signal is filtered, sampled and digitized, before the speech encoder 262 performs speech encoding applicable to the mobile telecommunications network. An output of the speech encoding/decoding block 260 is supplied to a channel encoding/decoding block 270, in which a channel encoder 272 will perform channel encoding upon the encoded speech signal in accordance with the applicable standard in the mobile telecommunications network.

An output of the channel encoding/decoding block 270 is supplied to a radio frequency (RF) block 280, comprising an RF transmitter 282, an RF receiver 284 as well as an antenna (not shown in FIG. 2). As is well known in the technical field, the RF block 280 comprises various circuits such as power amplifiers, filters, local oscillators and mixers, which together will modulate the encoded speech signal onto a carrier wave, which is emitted as electromagnetic waves propagating from the antenna of the mobile terminal 250.

After having been communicated across the channel 206, the transmitted RF signal, with its encoded speech data included therein, is received by an RF block 230 in the network station 200. In similarity with block 280 in the mobile terminal 250, the RF block 230 comprises an RF transmitter 232 as well as an RF receiver 234. The receiver 234 receives and demodulates, in a manner which is essentially inverse to the procedure performed by the transmitter 282 as described above, the received RF signal and supplies an output to a channel encoding/decoding block 220. A channel decoder 224 decodes the received signal and supplies an output to a speech encoding/decoding block 210, in which a speech decoder 214 decodes the speech data which was originally encoded by the speech encoder 262 in the mobile terminal 250. A decoded speech output 204, for instance a PCM signal, may be forwarded within the mobile telecommunications network 110 (to be transmitted to another mobile terminal included in the system) or may alternatively be forwarded to e.g. the PSTN 130 or the Internet 120.

When speech data is communicated in the opposite direction, i.e. from the network station 200 to the mobile terminal 250, a speech input signal 202 (such as a PCM signal) is received from e.g. the computer 122 or the stationary telephone 132 by a speech encoder 212 of the speech encoding/decoding block 210. After having applied speech encoding to the speech input signal, channel encoding is performed by a channel encoder 222 in the channel encoding/decoding block 220. Then, the encoded speech signal is modulated onto a carrier wave by a transmitter 232 of the RF block 230 and is communicated across the channel 206 to the receiver 284 of the RF block 280 in the mobile terminal 250. An output of the receiver 284 is supplied to the channel decoder 274 of the channel encoding/decoding block 270, is decoded therein and is forwarded to the speech decoder 264 of the speech encoding/decoding block 260. The speech data is decoded by the speech decoder 264 and is ultimately converted to an analog signal, which is filtered and supplied to a speaker 254, that will present the transmitted speech signal acoustically to the user of the mobile terminal 250.

As is generally known, the operation of the speech encoding/decoding block 260, the channel encoding/decoding block 270 as well as the RF block 280 of the mobile terminal 250 is controlled by a controller 290, which has associated memory 292. Correspondingly, the operation of the speech encoding/decoding block 210, the channel encoding/decoding block 220 as well as the RF block 230 of the network station 200 is controlled by a controller 240 having associated memory 242.

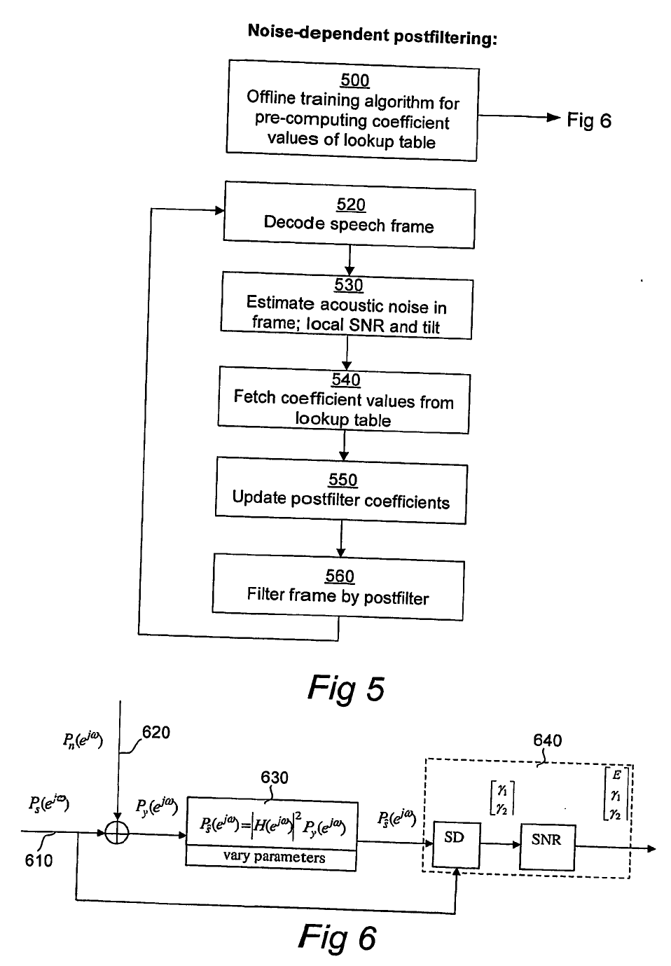

Reference will now be made to FIGS. 4 and 5, which illustrate an adaptive noise-dependent postfilter and its associated operation according to one embodiment. First, however, a theoretical discussion is given about the concept of postfiltering and how it can be done noise-dependent with adaptive filter coefficients according to the preferred embodiment.

The preferred embodiment uses a postfilter 404 designed for a CELP speech decoder 402, which is part of a speech filtering device 400. The speech filtering device 400 may constitute or be included in the speech encoding/decoding block (speech codec) 210 or 260 in FIG. 2. The postfilter 404 has a transfer function
H(z)=GHₛ(z) (1),

where G is a gain factor and Hₛ(z) is a filter of the form

$${H}_{s} ( z ) = \frac{A ( \frac{z}{{γ}_{1}} )}{A ( \frac{z}{{γ}_{2}} )} ( 1 - μ {z}^{- 1} ) \qquad ( 2 )$$

As previously mentioned, the postfilter will reduce the effect of quantization noise, particularly in low bit-rate speech coders, by emphasizing the formant frequencies and deemphasizing the valleys in between.

The postfilter uses two types of coefficients: linear prediction (LP) coefficients that adapt to the speech on a frame-by-frame basis and set of coefficients γ₁, γ₂ and μ which in a prior-art postfilter would be fixed at levels determined by listening tests but which in accordance with the invention are adapted to noise statistics estimated for the frame in question.

Hence, in equation (2), A(z) is a short-term filter function, γ₁ and γ₂ are coefficients that control the frequency response of this filter function (the degree of deemphasis) and μ controls a spectrum tilt compensation function (1−μz⁻¹) . The factor G aims to compensate for the gain difference between synthesized speech s(n) (s_{decoded} in FIG. 4) and post-filtered speech s_{f}(n) (sₒᵤₜ in FIG. 4). Let N be the number of samples for a frame. The gain scaling factor for the current frame is then computed as:

$$G = \sqrt{\frac{{\sum }_{n = 1}^{N} {s}^{2} ( n )}{{\sum }_{n = 1}^{N} {s}_{f}^{2} ( n )}} \qquad ( 3 )$$

The linear prediction coefficients for the current frame are those of the codec. The set of filter coefficients γ₁, γ₂ and μ are conventionally set to values that give the best perceptual performance for the particular codec under noise-free conditions. However, when background acoustic noise is added to the speech signal, the quantization noise is not audible and the traditional postfilter settings are not justified. Moreover, the gain factor G does not account for the fact that the energy of the synthesized noisy speech is higher than the energy of clean speech in the presence of background acoustic noise.

To deal with a variety of background noise sources, the set of postfilter coefficients should be made noise dependent. Postfilter coefficient values should be obtained for the variety of noise types that may contaminate the speech under real conditions. Thanks to the low number of postfilter coefficients, they are advantageously computed in advance, simulating different types and levels of the background noise.

Since the applied filter only shapes the envelope of the spectrum, spectral distortion (SD) is used as a measure of goodness of the filter coefficients. Let A(e^{jω}) denote the Fourier transform of the linear prediction polynomial (1, a₁, a₂, . . . , a₁₀) for the current frame. The SD measure evaluates the closeness between the clean speech auto-regressive envelope Aₛ(e^{jω}) and the auto-regressive envelope of the filtered noisy signal A_{ŝ}(e^{jω}) and is given by:

$${SD}^{2} = \frac{1}{2 π} {\int }_{- π}^{π} {( 10 {log}_{10} {\vert {A}_{s} ( {ⅇ}^{j ω} ) \vert}^{2} - 10 {log}_{10} {\vert {A}_{\hat{s}} ( {ⅇ}^{j ω} ) \vert}^{2} )}^{2} ⅆ ω \qquad ( 4 )$$

The values for the SD² are averaged over all speech frames by the quantity

$$\overline{SD} = \frac{1}{M} \sqrt{{\sum }_{n = 1}^{M} {SD}_{n}^{2}} \qquad ( 5 )$$

where M is the total number of frames.

Let A_{y}(e^{jω}) be the spectrum envelope of the noisy speech. Then, to see the dependency between optimized parameter and the filter coefficients, the expression for SD can be rewritten as:

$${SD}^{2} = \frac{1}{2 π} \int {( 10 {log}_{10} \frac{{\vert H ( {ⅇ}^{j ω} ) \vert}^{2} {\vert {A}_{y} ( {ⅇ}^{j ω} ) \vert}^{2}}{{\vert {A}_{s} ( {ⅇ}^{j ω} ) \vert}^{2}} )}^{2} ⅆ ω \qquad ( 6 )$$

As seen in FIG. 4, the speech filtering device 400 has a noise estimator 410. which is arranged to provide an estimation of the background noise in a current speech frame of an output speech signal s_{decoded} from the speech decoder 402. The speech filtering device 400 also has a postfilter controller 420 that will use the result from noise estimator 410 to select appropriate filter coefficient values 434 from a lookup table 430. This lookup table maps a plurality of values 432 of estimated relative noise energy (SNR) and noise spectrum tilt to a plurality of filter coefficient values 434. The post-filter controller 420 will supply the selected filter coefficient values as a control signal 422 to the post-filter 404, wherein its filter coefficients will be updated in order to eliminate or at least reduce the estimated background noise when filtering the current speech frame from the speech decoder 402.

Thus, the operation of the noise-dependent post-filtering provided by the speech filtering device 400 is as illustrated in FIG. 5. In a separate step 500 a training algorithm for pre-computing the contents 432, 434 of lookup table 430 is performed “off-line”. This training algorithm will be described in more detail later.

Then, on a frame-by-frame basis, a received signal s_{encoded} is processed by the speech filtering device 400 as follows. In step 520 the signal s_{encoded} is decoded into a decoded signal s_{decoded} by the speech decoder 402. In step 530 the noise estimator 410 estimates the acoustic noise in the current frame. As will be described in more detail later, the acoustic noise is estimated as two parameters, relative noise energy (local SNR) and tilt of noise spectrum, and since the lookup table contains a mapping between a plurality of predetermined SNR/tilt values and associated filter coefficient values, coefficient values that correspond to the estimated SNR and tilt values may easily be fetched from the lookup table in step 540.

In step 550, the postfilter 404 is updated with the thus selected filter coefficient values. In other words, the filter coefficients γ₁ and γ₂ of postfilter 404 are assigned the values that were fetched from the lookup table in step 540. Then, the current frame of the decoded speech signal s_{decoded} is filtered by the postfilter 404 and is ultimately provided as an output speech signal sₒᵤₜ.

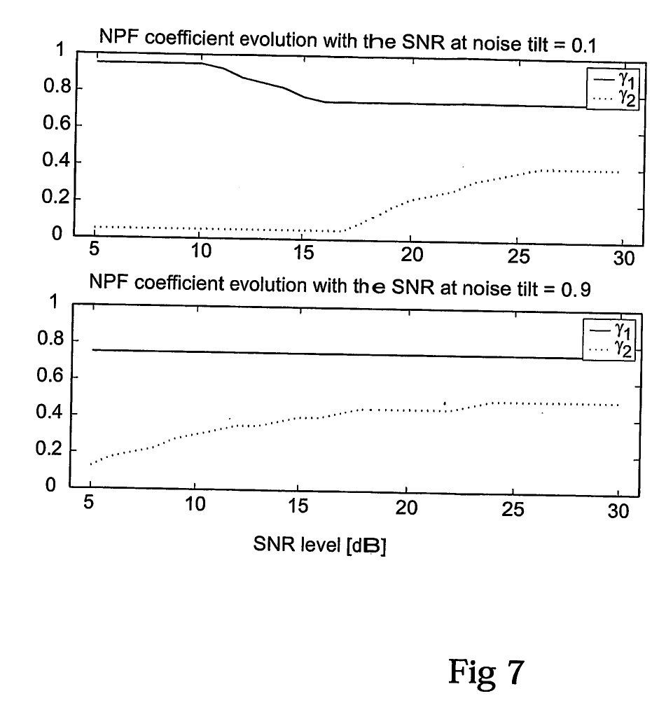

With reference to FIG. 6, the training algorithm of step 500 in FIG. 5 will now be described. The training algorithm is based on the assumption that the noise spectrum tilt (measured as the coefficients in the first order prediction polynomial) and the SNR take only discrete values, e.g., 1 dB step-size. Due to the special structure of the postfilter (highly reduced degrees of freedom), it is sufficient to model the noise with only these two parameters. The set of coefficients needed for the noise-dependent postfiltering can be calculated with the training algorithm, optimizing both the SD and the SNR. The presented algorithm is based on aforesaid parametric description of the speech and consists of four steps:

1. Build a database with clean speech power spectra Pₛ, calculated over 20 ms segments of clean speech.

2. Set the level of the SNR and the tilt of the noise spectrum. Add an artificial noise power spectrum Pₙ with the given tilt to the clean power spectra Pₛ in a way that the level of the SNR is preserved constant.

3. Apply the NPF on the current noisy power spectrum P_{y} with different sets of coefficients γ₁ and γ₂.
(a) Obtain the set of coefficients that gives the minimum overall \overline{SD}.
(b) For a given γ₁ and γ₂ obtain the gain factor G that optimizes the SNR.

4. Save the current SNR level, the tilt of Pₙ and the corresponding filter coefficients γ₁ and γ₂ in the lookup table 430. Go to 2.

Since the training algorithm is based on a parametric representation of the speech, a time domain formulation of SNR can not be used. In terms of power spectra the SNR is given by

$$SNR = 10 {log}_{10} ( \frac{{\sum }_{ω = 1}^{N} {P}_{s} ( {ⅇ}^{j ω} )}{{\sum }_{ω = 1}^{N} ( {P}_{\hat{s}} ( {ⅇ}^{j ω} ) - {P}_{s} ( {ⅇ}^{j ω} ) )} ) \qquad ( 7 )$$

where N is the number of frequency bins and P_{ŝ}(e^{jω}) is the filtered power spectra. SD is calculated according to equations (4) and (5).

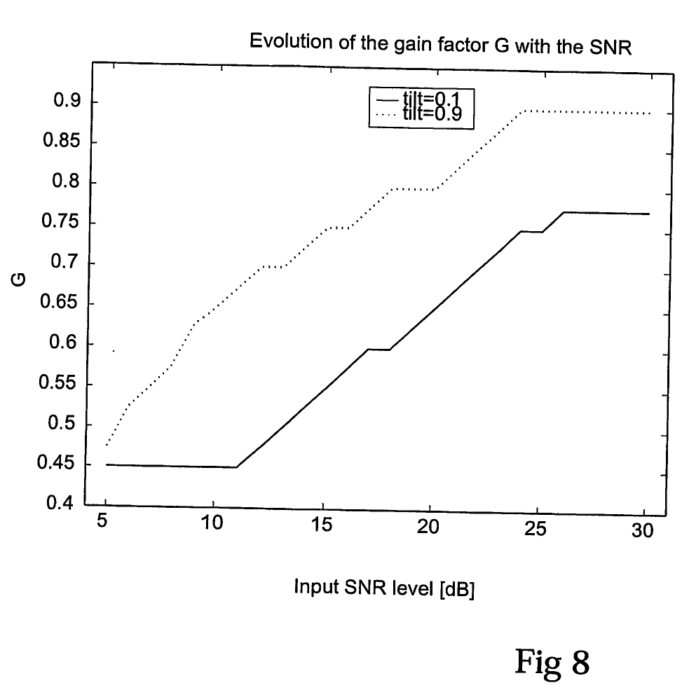

A diagrammatic illustration of the training algorithm is shown in FIG. 6. In FIG. 6, 610 denotes clean speech, 620 denotes noisy speech, 630 represents the postfilter, and 640 is a distortion measure block for SD and SNR. FIGS. 7 and 8 show the behavior of the filter coefficients obtained from the presented training algorithm. The smooth evolution of the filter coefficients with changing noise energy ensures stable performance under errors in the estimated noise parameters. From FIG. 7 it can be seen that the level of suppression depends on the “color” of the noise. More attenuation is performed for noise sources with a flat spectrum. With its reduced number of degrees of freedom the noise-dependent postfilter cannot suppress noise only in particular regions of the spectrum. In practice the performance of the noise-dependent postfilter for noise sources with a colored spectrum does not degrade, since most of their energy is concentrated in less audible regions, and therefore less attenuation is needed.

In the preferred embodiment, the acoustic noise estimating step 530 is performed according to the following algorithm. This algorithm allows estimation of the acoustic noise, in the form of aforesaid local SNR and tilt of the noise spectrum, at a significantly low computational burden compared to existing noise estimation methods. The main steps of the noise estimation algorithm according to the preferred embodiment are

1. Initialization:
Store the signal energy for a given frame in a buffer eBuff. Create a buffer tBuff of the same size for the noise spectrum tilt calculated for the current frame.

2. On a frame-by-frame basis:
(a) Update the buffers
   i. Update eBuff by removing the oldest value and add the energy of the current frame.
   ii. In the same manner update the tBuff with the current tilt of the spectrum.
(b) Estimate the noise parameters
   i. The minimum value in the eBuff becomes the estimate of the noise energy.
   ii. The estimate for the noise spectrum tilt is the element of tbuff with the index that has the minimum element in the eBuff.

The following table illustrates average test results from the estimation of the noise spectra tilt, for a sampling rate of 8 kHz, a frame size of 20 ms and a buffer length of 30. Ten clean speech sentences from a database known as TIMIT were contaminated with three types of stationary noise sources. The values in the column “True Tilt” were calculated over the noise frames, and the values in the column “Estimated Tilt” were given by the noise estimation algorithm described above. The values in the table below are obtained by averaging over all frames.

| Noise Type | True Tilt | Estimated Tilt |
|---|---|---|
| Car 5 dB | 0.99 | 0.96 |
| Babble 10 dB | 0.86 | 0.89 |
| White 0 dB | 0.04 | 0.08 |

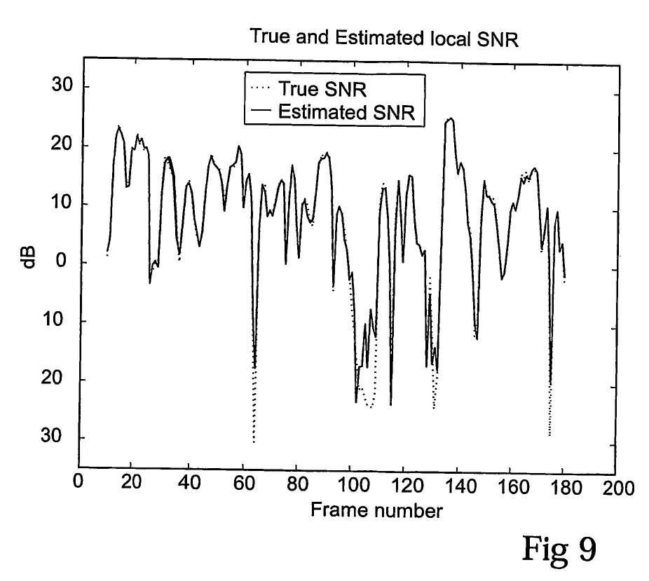

FIG. 9 illustrates the performance of the noise estimation algorithm described above over one clean speech sentence contaminated with white noise at 15 dB.

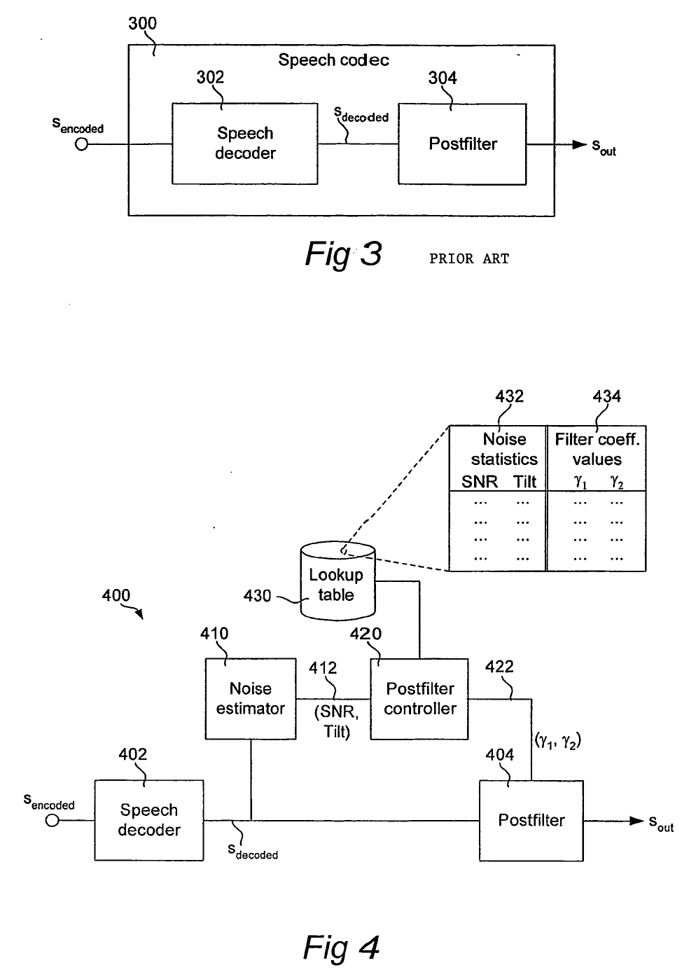

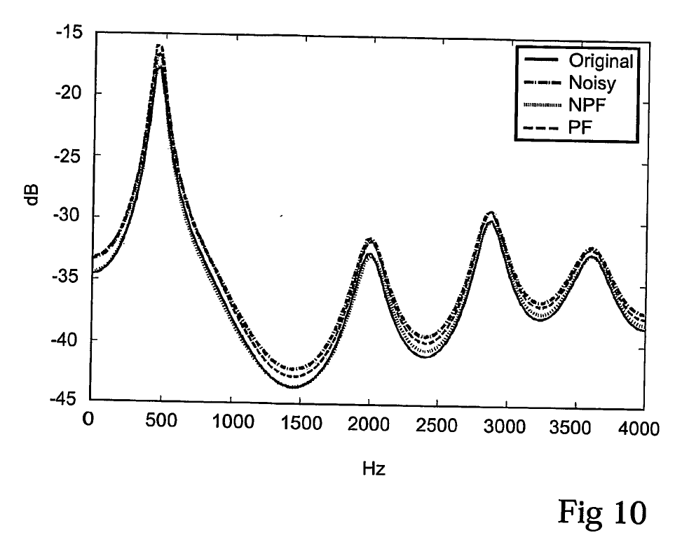

The performance of the noise-dependent post-filtering described above has been verified experimentally by comparing tests between a conventional EFR codec with a standard postfilter (FIG. 3) and an EFR codec with a noise-dependent postfilter (FIG. 4). These tests demonstrate that the EFR codec with the noise-dependent postfilter performs better, in terms of noise suppression, than the EFR codec with the standard postfilter. As an illustrative example, the spectral envelope of one representative speech segment is shown in FIG. 10. The noisy signal was obtained by adding factory noise at 10 dB to the original (clean) speech signal, and the noisy signal was then processed through both a standard postfilter and a noise-dependent postfilter to compare the noise attenuation. As appears from FIG. 10, the standard postfilter's coefficients are not adjusted to the particular noisy conditions, while the noise-dependent postfilter adapts to and successfully attenuates the unwanted noise.

Advantageously, the postfilter controller 420 may be adapted to check, following step 530, whether the estimated SNR for the current frame is below a predetermined threshold, such as 5 dB. Then, the frame is classified as a speech pause. In that case the controller 420 disables the postfilter so that no postfiltering of the current frame is applied and only energy attenuation is performed. Such suppression of the noise level in between speech segments has significant impact on the overall performance of a speech communication system, especially in high SNR conditions.

Other filter coefficients than γ₁ and γ₂, including but not limited to p and/or G in equations (1) and (2), may be adapted in the noise-dependent post-filtering according to the invention. It is possible, within the context of the invention, to perform noise-dependent post-filtering by adapting not only the coefficients of the short-term filter functions but also those of long-term filter functions. Moreover, the invention may be used with various types of speech decoders, CELP as well as others.

A speech filtering device according to the invention may advantageously be included in a speech transcoder in e.g. a GSM or UMTS network. In GSM, such a speech transcoder is called a transcoder/rate adapter unit (TRAU) and provides conversion between 64 kbps PCM speech from the PSTN 130 to full rate (FR) or enhanced full rate (EFR) 13-16 kbps digitized GSM speech, and vice versa. The speech transcoder may be located at the base transceiver station (BTS), which is part of the base station sub-system (BSS), or alternatively at the mobile switching center (MSC).

In an alternative embodiment, the noise-dependent speech filtering device according to the invention is used as a stand-alone noise suppression preprocessor at the encoder side of a speech codec. In this embodiment, the speech filtering device will receive an uncoded (not yet encoded) speech signal such as a PCM signal and perform noise suppression on the signal. The filtered and noise-suppressed output of the speech filtering device will be supplied as input to the speech encoder of the codec. The performance of the speech filtering device when used as such a preprocessor is similar to that of a Wiener filter or a spectral subtraction type noise reduction system.

As regards the training algorithm described with respect to FIG. 6, the optimized criterion used therein (i.e., SD (and SNR)) can be replaced by or combined with any psychoacoustically motivated distortion measure, such as PESQ (Perceptual Evaluation of Speech Quality), for improved performance. Alternative, use of conventional listening test is also possible. Moreover, the training algorithm can be used for minimizing the error rate in a particular speech recognition system (optimizing the perceived quality may not give optimal performance for a speech recognition system).

The noise-dependent speech filtering according to the invention may be realized as an integrated circuit (ASIC) or as any other form of digital electronics. It can be implemented as a module for use in various equipment in a mobile telecommunications network. Alternatively, it may be implemented as a computer program product, which is directly loadable into a memory of a processor—such as the controller 240/290 and its associated memory 242/292 of the network station 200/—mobile terminal 250 of FIG. 2. The computer program product comprises program code for providing the noise-dependent speech filtering functionality when executed by said processor.

The invention has mainly been described above with reference to a preferred embodiment. However, as is readily appreciated by a person skilled in the art, other embodiments than the ones disclosed above are equally possible within the scope of the invention, as defined by the appended patent claims.

1. A method of filtering a speech signal, the method involving the steps of providing a filter suited for reduction of distortion caused by speech coding; estimating acoustic noise in said speech signal; adapting said filter in response to the estimated acoustic noise to obtain an adapted filter; and applying said adapted filter to said speech signal so as to reduce acoustic noise and distortion caused by speech coding in said speech signal.

2. The method as defined in claim 1, wherein said step of adapting said filter involves adjusting filter coefficients of said filter.

3. The method as defined in claim 2, wherein said steps of estimating, adapting and applying are performed for portions of said speech signal which contain speech as well as for portions which do not contain speech.

4. The method as defined in claim 2, wherein said filter includes a short-term filter function designed for attenuation between spectrum formant peaks of said speech signal and wherein said filter coefficients include at least one coefficient that controls the frequency response of said short-term filter function.

5. The method as defined in claim 4, wherein said filter includes a spectrum tilt compensation function and wherein said filter coefficients include at least one coefficient that controls said spectrum tilt compensation function.

6. The method as defined in claim 1, wherein acoustic noise in said speech signal is estimated as relative noise energy (SNR) and noise spectrum tilt.

7. The method as defined in claim 2, wherein said step of adapting is performed by selecting values for said filter coefficients from a lookup table which maps a plurality of values of estimated acoustic noise to a plurality of filter coefficient values.

8. The method as defined in claim 1, wherein said steps of estimating, adapting and applying are performed after a step of decoding said speech signal.

9. The method as defined in claim 1, wherein said steps of estimating, adapting and applying are performed before a step of encoding said speech signal.

10. The method as defined in claim 1, wherein said speech signal comprises speech frames and wherein said steps of estimating, adapting and applying are performed on a frame-by-frame basis.

11. The method as defined in claim 7, further comprising the initial steps of generating said lookup table by: adding different artificial noise power spectra having given parameter (s) of acoustic noise to different clean speech power spectra ; optimizing a predetermined distortion measure by applying said filter to different combinations of clean speech power spectra and artificial noise power spectra; and for said different combinations, saving in said lookup table those filter coefficient values, for which said predetermined distortion measure is optimal, together with corresponding value (s) of said given parameter (s) of acoustic noise.

12. The method as defined in claim 11, wherein said predetermined distortion measure includes Spectral Distortion (SD).

13. The method as defined in claim 11, wherein said given parameters of acoustic noise include relative noise energy (SNR) and noise spectrum tilt.

14. The method as defined in claim 10, wherein acoustic noise in said speech signal is estimated as relative noise energy (SNR) and noise spectrum tilt, the method comprising the further steps, after said step of estimating acoustic noise, of deciding whether the estimated relative noise energy for a current speech frame is below a predetermined threshold; and if so, not performing said steps of adapting filter coefficients and applying said filter, and instead per-forming energy attenuation on the current speech frame so as to suppress acoustic noise in a speech pause.

15. An electronic apparatus having a speech filtering device for a speech signal, the speech filtering device comprising:
a filter suited for reduction of distortion caused by speech coding;
means for estimating acoustic noise in said speech signal; and
means for adapting said filter in response to the estimated acoustic noise,
wherein said filter, when applied to said speech signal, reduces acoustic noise and distortion caused by speech coding in said speech signal.

16. The electronic apparatus as in claim 15, wherein said means for adapting said filter is arranged to adjust filter coefficients of said filter in response to the estimated acoustic noise.

17. The electronic apparatus as in claim 16, wherein said means for estimating, said means for adapting and said filter are arranged to operate on portions of said speech signal which contain speech as well as on portions which do not contain speech.

18. The electronic apparatus as in claim 16, wherein said filter includes a short-term filter function designed for attenuation between spectrum formant peaks of said speech signal and wherein said filter coefficients include at least one coefficient that controls the frequency response of said short-term filter function.

19. The electronic apparatus as in claim 15, wherein said means for estimating acoustic noise is arranged to estimate it as relative noise energy (SNR) and noise spectrum tilt.

20. The electronic apparatus as in claim 16, wherein said means for adapting said filter comprises a lookup table, which maps a plurality of values of estimated acoustic noise to a plurality of filter coefficient values.

21. The electronic apparatus as in claim 15, wherein said speech signal comprises speech frames and wherein said means for estimating, said means for adapting and said filter are arranged to operate on said speech signal on a frame-by-frame basis.

22. (canceled)

23. (canceled)

24. (canceled)

25. (canceled)

26. A computer program product directly loadable into a memory of a processor, where the computer program product comprises program code for performing the method according to claim 1 when executed by said processor.

27. (canceled)

28. (canceled)

29. (canceled)

30. (canceled)

31. (canceled)
